(19) United States
(12) Patent Application Publication
(10) Pub. No.: US 2020/0028871 A1
(43) Pub. Date: Jan. 23, 2020

(54) USER ENTITY BEHAVIORAL ANALYSIS FOR PREVENTATIVE ATTACK SURFACE REDUCTION

(71) Applicant: Microsoft Technology Licensing, LLC, Redmond, WA (US)

(72) Inventors: Peter THAYER, Woodinville, WA (US); Deepak Jagannathan MANOHAR, Redmond, WA (US); Kambiz KOULADJIE, Woodinville, WA (US); Joseph Carl Nelson BLACKBIRD, Seattle, WA (US); Prachi RATHEE, Sammamish, WA (US)

(21) Appl. No.: 15/955,278

(22) Filed: Apr. 17, 2018

(51) Int. Cl. H04L 29/06

(52) U.S. Cl. CPC H04L 63/1433; H04L 63/1416; H04L 63/1475; H04L 63/145; H04L 63/1466

(57) ABSTRACT

Features of the present disclosure solve the above-identified problem by implementing user and entity behavior analytics (UEBA) system to group one or more computer machines into different clusters based on monitored behavior of the one or more computer machines. Specifically, a network device (e.g., administrator computer system) may monitor the activity of the one or more computer machines for a predetermined time period in order to identify the applications that the computer machines utilize. Based on the clustering and the identifying, the network device may automatically apply different access control policies for different clusters of machines and review those access control policies against future behavior periodically. By clustering machines based on usage behavior patterns and automatically recommending a rule set for deployment, the UEBA system may reduce potential points of failure for cybersecurity breaches.

### FIELD OF THE INVENTION

The invention generally relates to computer security (cybersecurity), and more specifically to automating prevention of cybersecurity threats by modifying the policies of end points based on user and entity behavior analytics to provide better protection against known vulnerabilities.

### BACKGROUND

Computer security refers to the processes and mechanisms which attempt to protect computer-based equipment, information and services from unintended or unauthorized access, change or destruction. With the proliferation of cloud and network oriented architecture, today's computer-based services and enterprise environments are frequently under attack and to some extent, compromised. Generally, in a network environment, a single point of failure may not only impact the affected computer, but may also adversely impact the entire network. Thus, for companies, risk of security breach may adversely affect data privacy and impact user productivity due to increased system down time.

### SUMMARY

Features of the present disclosure automatically apply prevention to the above-identified problem by implementing user and entity behavior analytics (UEBA) system to group one or more computer machines into different clusters based on monitored behavior of one or more computer machines. Specifically, a network device (e.g., administrator computer system) may monitor the activity of one or more computer machines for a predetermined time period in order to identify the applications that the computer machines utilize. Machines and users with like behavior patterns are clustered to reduce the possible permutations of attack surface reduction (ASR) rules manageable to system administrators. Based on the clustering and the identifying, the network device may automatically apply different access control policies for different clusters of machines. By automatically deploying a rule set, the UEBA system may reduce known cyber security vulnerabilities exploited in breaches. Moreover, the UEBA system can periodically analyze the behavior of the cluster and perform changes which optimize the cyber hygiene of the cluster.

In one example, a method for reducing computer security threat in a network is described. The method may include monitoring, at a network computer system, a usage behavior for a plurality of computer devices. The usage behavior may identify one or more of: applications; services; functionalities; or capabilities that the plurality of computer devices previously executed during a monitoring time period. The method may also include grouping the plurality of computer devices in one or more clusters based on the usage behavior. Further, the method may include identifying ASR parameters for each of the one or more clusters based on the computer resources they use and don't use. The ASR parameters may identify capabilities of the plurality of computer devices in each of the one or more clusters that may be configured to be selectively disabled or configured to decrease cyber-attack vulnerability. The method may further include disabling the one or more capabilities of the plurality of computer devices based at least on the ASR parameters.

In another example, a computer device for reducing computer security threat in a network is disclosed. The computer device may include a memory to store data and instructions, a processor in communication with the memory. The processor may be configured to execute instructions to monitor, at a network computer system, a usage behavior for a plurality of computer devices. The usage behavior may identify one or more of applications, services, functionalities or capabilities that the plurality of computer devices previously executed during a monitoring time period. The processor may further be configured to execute instructions to group the plurality of computer devices in one or more clusters based on the usage behavior. Further, the processor may be configured to execute instructions to identify ASR parameters for each of the one or more clusters. The ASR parameters may identify capabilities of the plurality of computer devices in each of the one or more clusters that may be configured to be selectively disabled or configured to decrease cyber-attack vulnerabilities. The processor may be further configured to disable the one or more capabilities of the plurality of computer devices based at least on the ASR parameters.

In another example, computer-readable medium storing instructions executable by a computer device for reducing computer security threat in a network is disclosed. The instructions may include code for monitoring, at a network computer system, a usage behavior for a plurality of computer devices. The usage behavior may identify one or more of applications, services, functionalities or capabilities that the plurality of computer devices previously executed during a monitoring time period. The instructions may further include code for grouping the plurality of computer devices in one or more clusters based on the usage behavior. The instructions may further include code for identifying ASR parameters for each of the one or more clusters. The ASR parameters may identify service reduction capabilities of the plurality of computer devices in each of the one or more clusters that may be configured to be selectively disabled. The instructions may further include disabling the one or more capabilities of the plurality of computer devices based at least on the ASR parameters.

In another example, a system for reducing computer security threat in a network is disclosed. The system may include monitoring, at a network computer system, a usage behavior for a plurality of computer devices. The system may further include periodically reviewing cluster usage behavior and identifying additional changes to service capabilities, both to improve security and/or to increase user productivity. The system may further enable or disable one or more capabilities of the plurality of computer devices in the cluster based on these subsequent discoveries.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 is an example of a computer network system for managing cybersecurity in accordance with various aspects of the present disclosure.

FIG. 2 is an example of the network system grouping the plurality of computer devices into a plurality of clusters based on user behavior in accordance with various aspects of the present disclosure.

FIG. 3 is a diagram illustrating an example of a hardware implementation for the network computer in accordance with various aspects of the present disclosure.

FIG. 4 is a flowchart of a method for time synchronizing an in-cell touch screen display with a stylus implemented by an in-cell digitizer in accordance with aspects of the present disclosure.

### DETAILED DESCRIPTION

As discussed above, today's computer systems are frequently under attack and to some extent, compromised. Generally, in a network environment, a single point of failure may compromise the entire network. The single point of failure may be a result of a breach from any one of applications, services, functionalities (individually and collectively “capabilities”) that may be enabled on any one computer device. Indeed, many computer devices today (e.g., laptops, computers, mobile devices, game consoles, etc.) have pre-installed capabilities that may be, by default, enabled on the system. However, in many instances, the user of the computer device may not have requested or needed one or more capabilities. Nonetheless, these enabled applications and services pose a security risk from unintended or unauthorized access, change or destruction. Such enabled applications and services may also provide an entry point into the network for a malicious attack.

In a network setting (e.g., corporation having thousands of issued laptops, computers, and mobile devices), individually managing security configurations for each computer device in the network may be impractical due to the sheer volume of the devices that may be involved. To manage the diversity of devices, many corporations utilize a set of pre-configured system images which they deploy to one or more sets of users. To keep the number of pre-configured system images manageable, many services and system capabilities are left enabled to allow for broader image distribution. While better protection could be enabled by having many, granular pre-configured system images providing only what is needed, from a manual implementation perspective, managing this complexity is very difficult.

Features of the present disclosure address the above-identified security management challenges by monitoring usage behavior patterns (at a network wide and/or granular personal computer devices level) and grouping the plurality of computer devices into one or more clusters based on the user entity behavior. For each of the clusters, the network computer system may identify and assign an attack surface reduction (ASR) policy, rule, or parameters that may be tailored to specific needs of the computer devices in each cluster. The ASR may function as an access control policy for the computer devices that may identify one or more applications, services, or capabilities of the computer device that may be disabled on the computer devices in each cluster. Because the ASR policy may be tailored for each cluster, the network computer system may be able to automatically deploy and manage vulnerabilities of each cluster based on the threats or vulnerabilities that may be unique to each cluster. Such an approach also provides an advantage over current systems because the techniques of the present disclosure decrease the need for qualified security analyst to continuously identify and deploy ASR in a time consuming and ad hoc manner. Moreover, through iteration, as the system is able to better map user-entity behavior to ASR rule configuration, cluster sizes can decrease providing unique, tailored systems with minimal attack surface on an individual user or machine basis.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

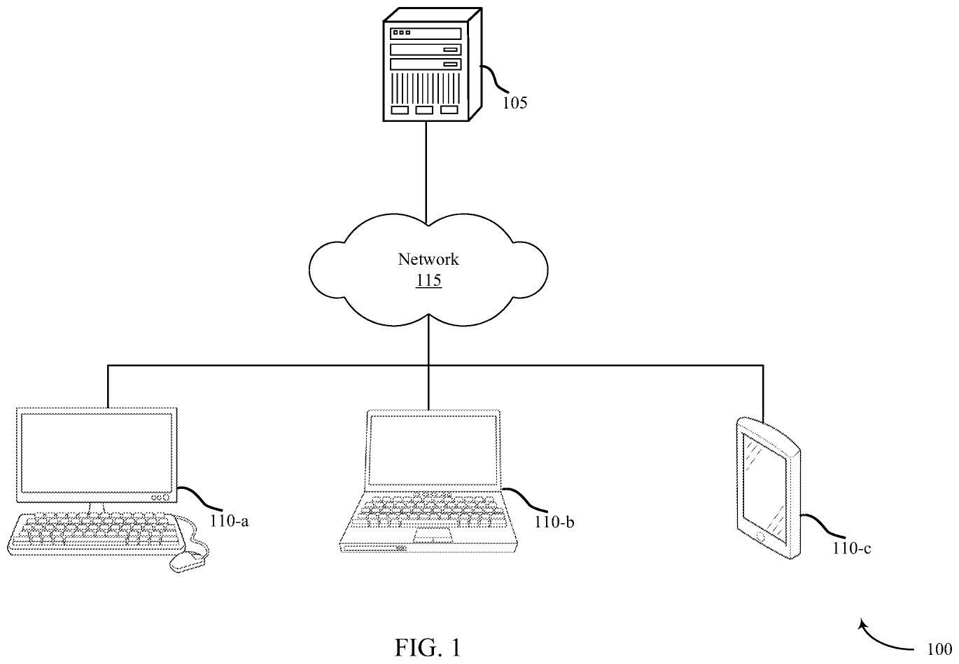

Turning first to FIG. 1, a computer network system 100 may include a plurality of computer devices 110 dispersed throughout the computer network system 100. An example of the computer devices 110 may include, but not limited to a desktop computer 110-a, a laptop 110-b, or a mobile device 110-c (e.g., mobile phones, tablets, etc.). Additionally, the plurality of computer devices 110 may be connected to a network computer 105 via a network 115 (e.g., local area network or internet) that may be a server with administrator privileges to control the functionalities of the one or more computer devices 110. While the computer devices 110 may communicate with the network computer 105, in some examples, the plurality of computer devices 110 may also communicate directly with each other using wired or wireless communication links.

The computer devices 110 may also include one or more applications, services, functionalities, or capabilities that may be enabled on the device. The applications, services, functionalities, or capabilities may be available to the user for execution and use. However, as noted above, these enabled applications and services may pose a security risk from unintended or unauthorized access, change or destruction. Such enabled applications and services may also provide an entry point into the network system 100 for a malicious attack. Reducing the attack surface of an end-point (computer devices 110) may mitigate the exposure to end-users for the computer network systems 100. Some examples of reducing the attack surface may include modifying firewall rules, Defender anti-virus rules, or Smart Screen rules. Additionally or alternatively, the attack surface may be reduced by disabling applications, services, functionalities, or capabilities that are not being used by the user of the computer device 110.

Specifically, many computer devices 110 have applications, services, functionalities, or capabilities that are enabled by default, yet may not be relevant or needed by a particular user or computer device. For example, a machine control computer that may be responsible for operating manufacturing equipment, for instance, may not necessarily need electronic mail (email) applications installed and enabled on that particular computer device 110. Thus, features of the present disclosure reduce the risk by dynamically disabling applications, services, functionalities, or capabilities that may not be needed for any particular device.

However, individually identifying each computer device 110 in the computer network system 100 may not be resource conscious. Specifically, it may require extensive resources (e.g., network administrator hours) to configure each computer device 110 in the network 100 to only the absolute set of services appropriate for each computer device 110. To this end, techniques described herein automate the identification of the required (and conversely, non-required) services and deploy control rules eliminating or disabling the unnecessary services automatically based on the user behavior. In some examples, the terms “unnecessary” or “non-required” may refer to applications, services, functionalities, or capabilities that may not have been used (or used as frequently) by the computer device 110.

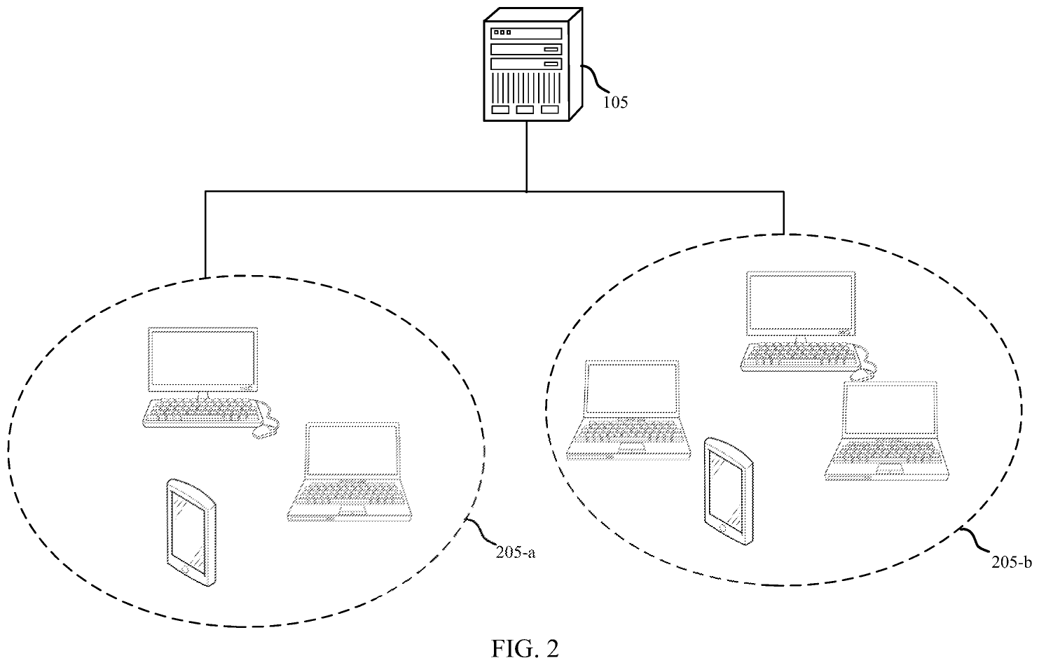

In order to facilitate the identification and deployment of ASR policies, the network computer 105, as illustrated in FIG. 2, may group the plurality of computer devices 110 into a plurality of clusters 205 based on usage behavior patterns of each computer device 110. For example, the network computer 105 may group a first set of computer devices 110 into a first cluster 205-a, and a second set of computer devices 110 to a second cluster 205-b comprising.

The network computer 105 may further identify ASR policies and parameters (or rule set) for deployment to the different clusters 205 that may be unique to each cluster 205. For example, while in the first cluster 205-a, the email and office suite may be identified as “unnecessary” or “non-required,” in the second cluster 205-b, a separate set of applications or services (e.g., internet access) may be identified as unnecessary. Accordingly, the network computer 105 may configure the computer devices 110 in each cluster 205 to selectively disable, deactivate, or uninstall the applications, services, functionalities, or capabilities that are identified as unnecessary for each cluster 205.

However, in order to group the plurality of computer devices 110 into various clusters based on the usage behavior patterns, the network computer 105 may first identity a set of available applications, services, functionalities, or capabilities installed on each computer device 110. To this end, the network computer 105 may construct a telemetry acquisition mechanism for identifying used and unused services on each computer device 110. One example of the telemetry acquisition mechanism may include monitoring, at a network computer 105, a usage behavior for a plurality of computer devices 110 where the usage behavior identifies one or more applications, services, functionalities, or capabilities that the plurality of computer devices may have executed during a predetermined monitoring time period.

While the number of devices assigned to cluster 205 may be initially large to accommodate human oversight of service reductions, subsequent iterations of cluster 205 generation will seek to shrink cluster sizes through improved automation and machine learning of user entity behavior and ASR application.

For purposes of this disclosure, the terms “usage behavior” or “usage behavior pattern” may refer to identification of applications, services, functionalities or capabilities such as software applications that the computer device has executed or alternatively not executed/used during the course of a predetermined monitoring time period. In some examples, the usage behavior determination may include identifying any macros (e.g., Office macros) that may be installed and/or executed on the computer device or the most commonly executed file types (e.g., PDF or Word document) and/or directories (e.g., file system) that may have been accessed. Additionally or alternatively, the usage behavior determination may include determining whether the USB ports for the computer device 110 are used, and if so, how they are generally used (e.g., whether USB ports are used for data transfer, headset configuration, as a charging port, etc.). Further, the usage behavior determination may include determining whether any applications inject data into other processes or whether any executed application spawns child processes. Even further, usage behavior determination may include determining how the executable content on the computer device 100 may be accessed by the user (e.g., email from within Outlook or Webmail client). Additionally, the usage behavior determination may include determining whether the computer device 110 supply a remote share or use a remote share, and whether one or more of remote desk protocol (RDP), file transfer protocol (FTP), internet information services (IIS), remote procedure call (RPC) services, distributed component object model (DCOM) services may be enabled and/or used during the predetermined monitoring time period. Additionally or alternatively, the usage behavior determination may include identifying the one or more threads and/or processes that may be executed and used during the predetermined monitoring time period. In general, a usage behavior pattern is any machine or entity behavior which opens up a computer security vulnerability that can be exploited.

Based on the identification of the usage behavior pattern that may include non-limiting examples discussed above, the network computer 105 may process the telemetry data to identify clusters 205 of computer devices 110 that exhibit similar usage behavior. Upon identifying the clustered computer devices 110, the network computer 105 may tag each machine with the corresponding cluster identification (ID). Accordingly, the network computer 105 may group each of the computer devices 110 and machines in the network that generally use the same applications, services, functionalities or capabilities based on the cluster ID. For example, the network computer 105 may group a first set of computer devices 110 into a first cluster 205-a, and a second set of computer devices 110 to a second cluster 205-b comprising.

Once the network computer 105 groups the plurality of computer devices 110 into corresponding clusters 205, the network computer 105 may identify ASR rules (e.g., applications, services, functionalities and/or capabilities that may be disabled or deactivated) for each cluster 205. In some examples, the network computer 105 may identify a first set of ASR rules for the first cluster 205-a, and a second set of ASR rules for the second cluster 205-b. For purposes of this disclosure, the terms “ASR rules,” “ASR policy,” or “ASR parameters” may be used interchangeably throughout the disclosure. The ASR rules and parameters may be packaged and transmitted to each cluster 205 and corresponding computer devices 110 for adoption.

Upon receiving the ASR rules package, the one or more computer devices 110 may execute the ASR rules and disable or deactivate applications, services, functionalities and/or capabilities that are identified by the network computer 105 as unnecessary or unneeded for any particular cluster 205 of computer devices 110. Conversely, if any computer device 110, at a later time, requires access to any disabled or deactivated applications, services, functionalities and/or capabilities, the computer device 110 may issue a request to the network computer 105 for regrouping the requesting computer device 110 into a cluster 205 that may include access to the disabled applications, services, functionalities and/or capabilities.

Once the cluster in 205 receives and executes the ASR rules, the network computer 105 may continue to monitor application usage in computer device 110 looking for additional changes or improvements that can be made to improve overall system security and productivity. If changes are identified, the network computer 105 issues additional instructions to the cluster 205 composed of one or more computer devices 110.

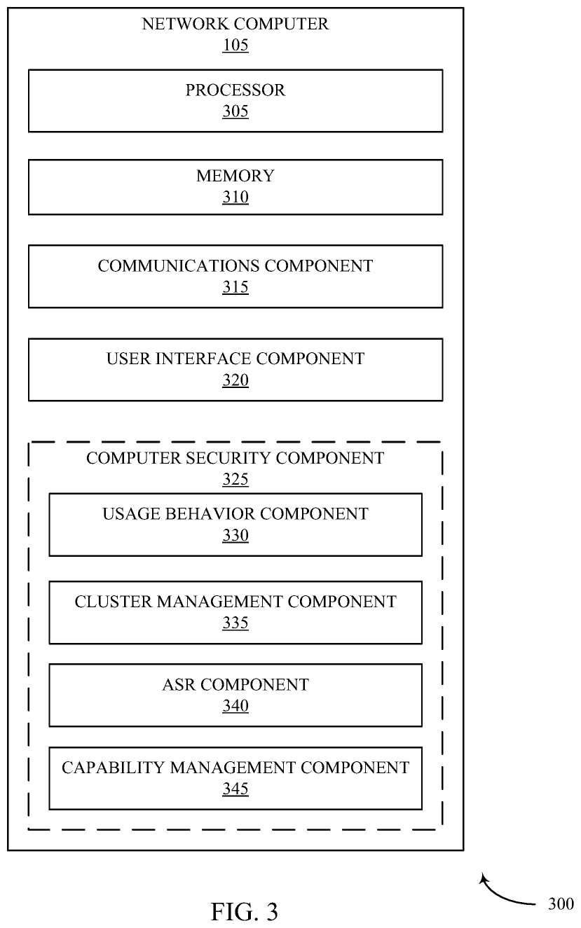

Referring now to FIG. 3, a diagram illustrating an example of a hardware implementation for the network computer 105 in accordance with various aspects of the present disclosure is described. In some examples, the network computer 105 may be an example of the network computer 105 described with reference to FIGS. 1-2. The network computer 105 may include a processor 305 for carrying out one or more processing functions (e.g., method 400) described herein. The processor 305 may include a single or multiple set of processors or multi-core processors. Moreover, the processor 305 can be implemented as an integrated processing system and/or a distributed processing system.

The network computer 105 may further include memory 310, such as for storing local versions of applications being executed by the processor 305. In some aspects, the memory 310 may be implemented as a single memory or partitioned memory. In some examples, the operations of the memory 310 may be managed by the processor 305. Memory 310 can include a type of memory usable by a computer, such as random access memory (RAM), read only memory (ROM), tapes, magnetic discs, optical discs, volatile memory, non-volatile memory, and any combination thereof. Additionally, the processor 305, and memory 310 may include and execute operating system (not shown).

Further, the network computer 105 may include a communications component 315 that provides for establishing and maintaining communications with one or more parties utilizing hardware, software, and services as described herein. Communications component 315 may carry communications between components and modules of the network computer 105. The communications component 315 may also facilitate communications with external devices to the network computer 105, such as to electronic devices coupled locally to the network computer 105 and/or located across a communications network and/or devices serially or locally connected to network computer 105. For example, communications component 315 may include one or more buses operable for interfacing with external devices.

The network computer 105 may also include a user interface component 320 operable to receive inputs from a user of the network computer 105 and further operable to generate outputs for presentation to the user. User interface component 320 may include one or more input devices, including but not limited to a navigation key, a function key, a microphone, a voice recognition component, any other mechanism capable of receiving an input from a user, or any combination thereof. Further, user interface component 320 may include one or more output devices, including but not limited to a display, a speaker, any other mechanism capable of presenting an output to a user, or any combination thereof.

The network computer 105 may further include a computer security component 325 for grouping the plurality of computer devices 110 under the control of the network computer 105. Particularly, the computer security component 325 may include a usage behavior component 330 for monitoring the usage behavior of the plurality of computer devices 110 during a predetermined monitoring time period (e.g., 2-3 weeks) to identify usage behavior patterns amongst the plurality of computer devices 110. The cluster management component 335 may group the plurality of computer devices 110 into one or more clusters based on the usage behavior patterns.

The network computer 105 may further include ASR component 330 to identify and assign ASR rules and parameters to each cluster. Based on the ASR rules, the capability management component 345 may issue instructions or commands to the plurality of computer devices 110 in each cluster to disable or deactivate one or more of applications, services, functionalities and/or capabilities of the computer device 110.

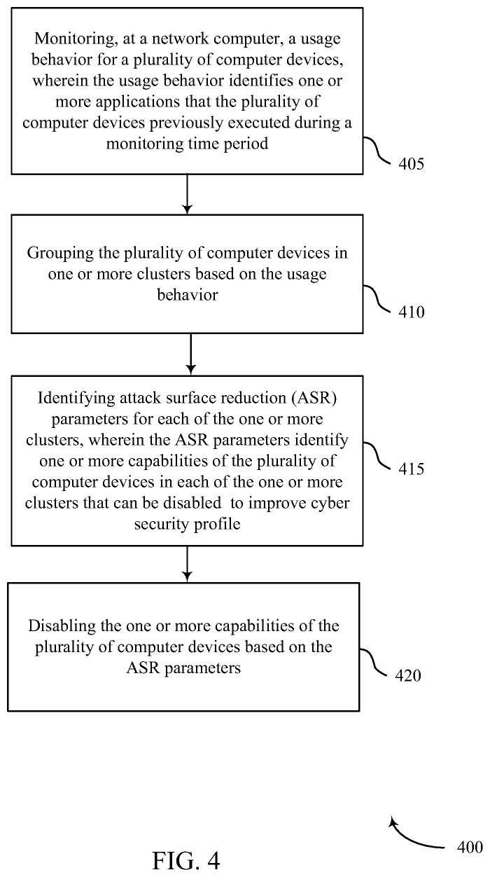

Turning next to FIG. 4, method 400 for reducing computer security threat in a network is described. The method 400 may be performed by the network computer as described with reference to FIGS. 1 and 2. Although the method 400 is described below with respect to the elements of the network computer 105, the method 400 may be performed by any computer or network system capable of processing telemetry to identify usage behavior.

At block 405, the method 400 may include monitoring, at a network computer system, a usage behavior for a plurality of computer devices in the network, wherein the usage behavior identifies one or more of applications or services that the plurality of computer devices previously executed during a monitoring time period. The applications or services may include one or more of software applications, system services, ports, protocols, or computer capabilities that represents a security vulnerability for the network. The usage behavior may further identify non used applications that each of the plurality of computer devices has failed to execute during the monitoring time period. The monitoring time period may be either predetermined or dynamically adjustable. Aspects of block 405 may be performed by the usage behavior component 330 described with reference to FIG. 3.

At block 410, the method 400 may include grouping the plurality of computer devices in one or more clusters based on the usage behavior. In some examples, the network computer may group a first set of computer devices from the plurality of computer devices in a first cluster based on the usage behavior. The network computer may further group a second set of computer devices from the plurality of computer devices in a second cluster based on the usage behavior.

In some instances, the computer device may request re-enablement of previously disabled capability or feature. To this end, the network computer may receive a request from at least one computer device of the plurality of computer devices to re-enable a disabled capability. Based upon the request, the network computer may enable the previously disabled capability for the at least one computer device within the computer devices by transmitting an enabling request to the requesting computer device. In some examples, re-enabling may include regrouping the at least one computer device requesting re-enablement of the disabled capability to a different cluster. Aspects of block 410 may be performed by the cluster management component 335 described with reference to FIG. 3.

At block 415, the method 400 may include identifying ASR parameters for each of the one or more clusters, wherein the ASR parameters identify capabilities of the plurality of computer devices in each of the one or more clusters that are configured to be selectively disabled to improve cyber security profile of the plurality of computer devices and the network. The capabilities may refer to one or more of applications, services, or functionalities available for section or use on at least one computer device 110 in the network. In some examples, the network computer may assign a first set of ASR parameters to the first set of computer devices in a first cluster, and a second set of ASR parameters to the second set of computer devices in a second cluster. Aspects of block 415 may be performed by the ARS component 340 described with reference to FIG. 3.

At block 420, the method 400 may include disabling the one or more capabilities of the plurality of computer devices based on the ASR parameters. Aspects of block 420 may be performed by the capability management component 345 described with reference to FIG. 3.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a device, which can be a wired device or a wireless device. A wireless device may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It should be appreciated to those of ordinary skill that various aspects or features are presented in terms of systems that may include a number of devices, components, modules, and the like. It is to be understood and appreciated that the various systems may include additional devices, components, modules, etc. and/or may not include all of the devices, components, modules etc. discussed in connection with the figures.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media. While aspects of the present disclosure have been described in connection with examples thereof, it will be understood by those skilled in the art that variations and modifications of the aspects described above may be made without departing from the scope hereof. Other aspects will be apparent to those skilled in the art from a consideration of the specification or from a practice in accordance with aspects disclosed herein.

What is claimed is:

1. A method for reducing computer security threats in a network, comprising:
monitoring, at a network computer, a usage behavior for a plurality of computer devices in the network, wherein the usage behavior identifies one or more applications or services that the plurality of computer devices previously executed during a monitoring time period;
grouping the plurality of computer devices in one or more clusters based on the usage behavior;
identifying attack surface reduction (ASR) parameters for each of the one or more clusters, wherein the ASR parameters identify one or more capabilities of the plurality of computer devices in each of the one or more clusters that are configured to be selectively disabled to improve cyber security profile; and
disabling the one or more capabilities of the plurality of computer devices based at least on the ASR parameters.

2. The method of claim 1, wherein grouping the plurality of computer devices in the one or more clusters based on the usage behavior, comprises:
grouping a first set of computer devices from the plurality of computer devices in a first cluster based on the usage behavior; and
grouping a second set of computer devices from the plurality of computer devices in a second cluster based on the usage behavior.

3. The method of claim 2, wherein identifying the ASR parameters for each of the one or more clusters, comprises:
identifying a first set of ASR parameters to the first set of computer devices; and
identifying a second set of ASR parameters to the second set of computer devices, wherein the first ASR parameters and the second ASR parameters are different.

4. The method of claim 1, wherein the usage behavior further identifies nonuse applications that each of the plurality of computer devices has failed to execute during the predetermined monitoring time period.

5. The method of claim 1, further comprising:
receiving a request from at least one computer device of the plurality of computer devices to re-enable a disabled capability; and
enabling the disabled capability for the at least one computer device of the plurality of computer devices based on the request.

6. The method of claim 5, further comprising:
regrouping the at least one computer device requesting re-enablement of the disabled capability to a different cluster.

7. The method of claim 1, further comprising:
reviewing, periodically, machine behavior in the one or more clusters; and
modifying the applied ASR parameters to improve overall cyber hygiene and cluster productivity.

8. The method of claim 1, further comprising:
reviewing, periodically, cluster allocation of the one or more clusters and the applied ASR parameters; and
applying the usage behavior learned to further decrease cluster size for the one or more clusters and increase ASR security prevention coverage.

9. The method of claim 1, wherein the capabilities of the plurality of computer devices include one or more of applications, services, or functionalities available for execution or use.

10. The method of claim 1, wherein the applications or services include one or more of software applications, system services, ports, protocols, or computer capabilities that represents a security vulnerability.

11. A computer device for reducing computer security threats in a network, comprising:
a memory to store data and instructions; and
a processor in communication with the memory to execute the instructions to:
monitor, at a network computer, a usage behavior for a plurality of computer devices in the network, wherein the usage behavior identifies one or more applications or services that the plurality of computer devices previously executed during a monitoring time period;
group the plurality of computer devices in one or more clusters based on the usage behavior;
identify attack surface reduction (ASR) parameters for each of the one or more clusters, wherein the ASR parameters identify one or more capabilities of the plurality of computer devices in each of the one or more clusters that are configured to be selectively disabled to improve cyber security profile; and
disable the one or more capabilities of the plurality of computer devices based at least on the ASR parameters.

12. The computer device of claim 11, wherein the instructions to group the plurality of computer devices in the one or more clusters based on the usage behavior, further include instructions to:
group a first set of computer devices from the plurality of computer devices in a first cluster based on the usage behavior; and
group a second set of computer devices from the plurality of computer devices in a second cluster based on the usage behavior.

13. The computer device of claim 12, wherein the instructions to identify the ASR parameters for each of the one or more clusters, further include instructions to:
identify a first set of ASR parameters to the first set of computer devices; and
identify a second set of ASR parameters to the second set of computer devices, wherein the first ASR parameters and the second ASR parameters are different.

14. The computer device of claim 11, wherein the usage behavior further identifies nonuse applications that each of the plurality of computer devices has failed to execute during the predetermined monitoring time period.

15. The computer device of claim 11, further comprising instructions to:
receive a request from at least one computer device of the plurality of computer devices to re-enable a disabled capability; and
enable the disabled capability for the at least one computer device of the plurality of computer devices based on the request.

16. The computer device of claim 15, further comprising instructions to:
regroup the at least one computer device requesting re-enablement of the disabled capability to a different cluster.

17. The computer device of claim 11, wherein the capabilities of the plurality of computer devices include one or more of applications, services, or functionalities available for execution or use.

18. A computer-readable medium storing instructions executable by a computer device for reducing computer security threats in a network, the instructions comprising code for:
monitoring, at a network computer, usage behaviors for a plurality of computer devices in the network, wherein the usage behaviors identifies one or more applications or services that the plurality of computer devices previously executed during a monitoring time period;
grouping the plurality of computer devices in one or more clusters based on the usage behaviors;
identifying attack surface reduction (ASR) parameters for each of the one or more clusters, wherein the ASR parameters identify one or more capabilities of the plurality of computer devices in each of the one or more clusters that are configured to be selectively disabled to improve cyber security profile; and
disabling the one or more capabilities of the plurality of computer devices based at least on the ASR parameters.

19. The computer-readable medium of claim 18, wherein the code for grouping the plurality of computer devices in the one or more clusters based on the usage behavior, further comprises code for:
grouping a first set of computer devices from the plurality of computer devices in a first cluster based on the usage behavior; and
grouping a second set of computer devices from the plurality of computer devices in a second cluster based on the usage behaviors.

20. The computer-readable medium of claim 19, wherein the code for identifying the ASR parameters for each of the one or more clusters, comprises code for:
identifying a first set of ASR parameters to the first set of computer devices; and
identifying a second set of ASR parameters to the second set of computer devices, wherein the first set of ASR parameters and the second set of ASR parameters are not identical.
